(19) United States
(12) Patent Application Publication
(10) Pub. No.: US 2020/0139593 A1
(43) Pub. Date: May 7, 2020

(54) METHOD FOR PRODUCING A FOAM BODY, AND FOAM BODY

(71) Applicants: Alois ZORN, Wien (AT); Florian NOWY, Wien (AT)

(72) Inventor: Florian NOWY, Wien (AT)

(73) Assignees: Alois ZORN, Wien (AT); Florian NOWY, Wien (AT)

(21) Appl. No.: 16/608,998

(22) PCT Filed: Apr. 26, 2018
(86) PCT No.: PCT/AT2018/060080

§ 371 Date: Oct. 28, 2019

(30) Foreign Application Priority Data
May 2, 2017 (AT) A 50353/2017

(51) Int. Cl. B29C 44/34; B29C 44/44; B29K 105/04; B29K 101/12; B29C 67/20

(52) U.S. Cl. CPC B29C 44/3461; B29C 44/445; B29K 2995/0063; B29C 67/205; B29K 2101/12; B29C 44/3415; B29K 2105/04

(57) ABSTRACT

The invention relates to a method for producing a foam material body, as well as to a foam material body. A pourable starting granulate of expanded particles of a thermoplastic material is provided, which is subjected to a non-melting heat treatment. As a result, an intermediate granulate is formed with a bulk density higher than that of the starting granulate. The foam material body is then formed by materially connecting the volume-reduced particles of the intermediate granulate by heating the intermediate granulate to a temperature greater than a glass transition temperature of the thermoplastic material in the molding cavity of a molding tool and then solidifying the thermoplastic material by cooling. The foam material body exhibits an overall density between 80 kg/m³ and 600 kg/m³.

The invention relates to a method for producing a foam material body, as well as to a foam material body.

For many decades, foam material products made from foamed plastic materials have been produced for various purposes. Polystyrene is by far the most frequently used plastic material for the production of foams. In particular, expanded polystyrene particle foam (EPS)—as known for example under the brand name Styropor®—is used for various purposes, for example as packaging or as an insulation material.

Common methods of producing such foam products consist of at least one foaming process, during which a plastic substance containing a foaming agent is heated and expands as the foaming agent volatilizes, thereby reducing the apparent density and/or bulk density of the plastic material. Subsequently the foamed plastic material may, for example, be placed in interim storage. Next, the plastic material generally undergoes a second foaming process, during which the respective foam product is also formed.

While the foam products manufactured in this manner may be used for some purposes thanks to their inherent characteristics, the possible areas of application for these products are limited primarily due to their insufficient mechanical properties, such as can be the case with foamed EPS products. For example, these foam products cannot be used for applications that require sufficiently sound mechanical properties such as specific compressive, tensile, and/or flexural strengths.

In the past, a type of process was discovered by which a body of expanded foam material is subjected to heat treatment of one of the plastic materials forming the foam. This kind of method has been disclosed, for example, in WO 2006/086813 A1, EP 1 853 654 B1 and U.S. Pat. No. 8,765,043 B2. This heat treatment achieves a reduction in volume of the material as relative to its initial state prior to heat treatment. However, this familiar method still reveals deficits regarding the process involved. In particular, it is not possible to establish satisfactory control over the volume reduction—and/or shrinkage—of the initial material, so that shaping of the reduced-volume foam material product requires post-process shaping. The resulting foam material product must be converted into a usable form, for example through cutting, milling, or sawing. On the one hand, this results in increased process costs, and on the other hand there is an increase in waste material, such as losses through milling and/or cutting, etc. Furthermore, the process can result in foam products with relatively large differences in density in various areas of the respective product.

The object of the present invention was to overcome the remaining disadvantages of the prior art and to provide an improved process by which foam material bodies with good mechanical properties can be produced in an efficient manner and essentially without the accumulation of waste material. Furthermore, it was an object of the invention to provide an improved foam material body with the lowest possible differences in density across all areas of the foam material body.

This problem is solved using a method as described in claims 1 to 18, and a foam material body as described in claims 19 and 20.

The method for producing a foam material body comprises these steps:
provision of a pourable starting granulate of expanded particles of a thermoplastic material,
formation of a pourable intermediate granulate having a bulk density higher than that of the starting granulate through volume reduction of the particles of the starting granulate by subjecting the starting granulate to a non-melting heat treatment, and
molding of the foam material body through material connection of the volume-reduced particles of the intermediate granulate by heating the intermediate granulate in the molding cavity of a shaping tool to a temperature higher than the glass transition temperature of the thermoplastic material, and by subsequently solidifying the thermoplastic material via a cooling process.

The term “starting granulate” in this document designates an initial bulk material. The term “intermediate granulate” in this document designates an intermediate bulk material.

Foam material bodies with good mechanical properties can be produced through the method specified here. In particular, it enables the production of foam material bodies with improved compressive, tensile, and flexural strength in comparison to the starting materials. For this reason, the resulting foam material bodies can also be used in areas of application that require enhanced mechanical strengths. The use of the foam material bodies as insulating elements for building construction, such as for the thermal decoupling of load-bearing building components, is only one example. In addition, the resulting foam material bodies and/or molded bodies can be used as lightweight structural elements, for example in technical fields such as vehicle manufacturing. Another example worthy of mention is the use of the foam material bodies to create buoyancy for liquid-borne loads.

Due to the use of non-melting heat treatment, the volume of the expanded particles of the starting granulate can be shrunk without binding the particles together. The degree of shrinkage can be influenced by adjusting the temperature and the duration of heat treatment. This advantage enables the targeted influence of a desired bulk density for the intermediate granulate. This already provides an intermediate granulate with the respective desired bulk density for the subsequent molding of the foam material body, thus making the time needed for the subsequent molding step very short. Furthermore, the desired properties for the foam material body resulting from the molding step, such as the thermal insulation values or flexural or compressive strength, can be influenced in a targeted manner.

Higher temperatures during heat treatment can achieve a higher reduction in the volume of the expanded particles of the starting granulate. It is thereby possible to form an intermediate granulate with a greater bulk density than when using lower temperatures during heat treatment. The temperature during the heat treatment ultimately determines the maximum achievable volume reduction for the particles of the starting granulate and/or the maximum achievable bulk density of the intermediate granulate. Moreover, a longer duration of the non-melting heat treatment can achieve an increase in bulk density of the intermediate granulate versus a shorter one. As an advantage, by selecting the temperature and duration as parameters of the non-melting heat treatment, selectively influencing the bulk density of the intermediate granulate becomes possible.

Preferably, the non-melting heat treatment for the formation of the pourable intermediate granulate will be carried out at or just above the range of the glass transition temperature and/or softening temperature of the respective thermoplastic material. In this document, the term “glass transition temperature” refers to the material-dependent lower limit of a glass transition range, at which the amorphous parts begin to soften for a particular thermoplastic material, as is known per se for thermoplastic materials. The temperature for a given non-melting heat treatment is selected in such a manner that it lies below any melting temperatures of the respective thermoplastic material.

Through this non-melting heat treatment, the expanding particles of the starting granulate are converted into a soft-elastic state. In this soft-elastic state, the thin walls of the expanded particles of the starting granulate contract uniformly, proceeding from their expansion in the stressed state induced by their manufacture, thereby reducing the volume of the particles and forming an intermediate granulate with a bulk density greater than the bulk density of the starting granulate. Any residual foaming agent present in the starting granulate is volatilized in the course of the non-melting heat treatment, so that the pourable starting granulate is subjected to a non-foaming heat treatment.

This process has proven advantageous over the prior art in that, by heat treating the starting granulate and by forming a pourable intermediate granulate as a basis for the subsequent molding of the foam material body, the foam material body can be shaped directly in the molding tool. In general, this can essentially eliminate the need for any further shaping steps in post-processing such as cutting, sawing, or milling. As a further consequence, the accumulation of waste material, for example through cuttings, can also be prevented. Any minor post-processing, such as superficial grinding, etc., will produce only small amounts of waste material. Where appropriate, it is also possible to ensure that waste materials from post-process machining are reused later in the process by mixing such waste material with an intermediate granulate prior to molding in the molding tool. Here it is possible that such waste material is again generated in granular, pourable form during post-processing or is crushed to pourable granulate.

The specified measures for molding the foam material body make it possible to provide a foam material body whereby the geometric boundary surfaces of the resulting foam material body can be specified at least predominantly by the design of the molding cavity.

Another advantage over the prior art is that due to the present method's process control, it is possible to produce foam material products with very small differences in density in different areas of the respective foam material product. On the one hand, it has been shown that the heat treatment of a starting granulate, in contrast to the heat treatment of a starting body, can better compensate for differences in the density of the starting material. Thus, differences in the apparent density of the volume-reduced particles of the intermediate granulate can be reduced by the heat treatment when compared with differences in the apparent density of the provided expanded particles of the starting granulate. Furthermore, the method provides the possibility of separating or classifying the volume-reduced particles of the intermediate granulate with regard to a given apparent density, and of applying and/or using the respectively volume-reduced particles having at least predominantly uniform bulk density for the subsequent shaping of the foam material body.

Overall, the described measures provide a simple process which can be used to modify the properties of common and easily available starting materials and to produce foam material bodies suitable for new areas of application where these starting materials cannot be used. Compared to the prior art, in which a body is subjected to heat treatment, there are other advantageous possibilities for further processing due to the formation of a pourable intermediate granulate during heat treatment.

In principle, any expanded thermoplastic material can be used in this process. In practice, alongside foamed materials made from polyethylene or polypropylene, primarily polystyrene foam material products are available as a starting material. Crosslinked, thermoset foam material objects cannot be used for this method as the volume of these substances cannot be reduced through heat treatment.

In one embodiment of the present method, it can be provided for that in order to provide the starting granulate, foam material objects are crushed from the thermoplastic material.

This may include, for example, packages made of polystyrene foam or thermal insulation panels made of polystyrene. Such starting materials can be crushed to form the starting granulate simply and cost-effectively. In principle any comminution device can be used, such as a shredder. As an advantage, even a wide variety of starting materials can thereby be recycled and then processed into usable foam material bodies.

Here it is quite possible to crush foam material objects of different densities.

This is entirely feasible with this method, since the non-melting heat treatment allows the creation of an intermediate granulate with a more balanced apparent density of the volume-reduced particles in comparison to the expanded particles of the starting granulate. Furthermore, due to the pourable form of the intermediate granulate, the intermediate granulate can further be classified by density prior to molding the foam material body.

In an efficient embodiment of the presented method, it can be provided for that by the heat treatment, the bulk density of the intermediate granulate is increased to 5 times to 40 times the amount with respect to the bulk density of the starting granulate prior to heat treatment.

By forming such a condensed intermediate granulate with an increased bulk density, it is thus possible to subsequently produce foam material bodies with improved mechanical properties.

The respective desired increase of the bulk density through reduction in the volume of the starting-granulate particles may be selected primarily by adjusting the temperature and duration of the non-melting heat treatment.

In particular it is possible, via the heat treatment, to preselect a bulk density of the intermediate granulate from a range between 50 kg/m³ and 500 kg/m³.

By the targeted formation of an intermediate granulate with a bulk density in the specified range, it is possible to directly produce a foam material body with respectively adjusted properties in the subsequent molding phase. An intermediate granulate having a bulk density selected from the specified range is particularly suitable for producing foam material bodies with improved mechanical properties. For example, by forming a high-bulk-density intermediate granulate, foam material bodies can be produced that have a higher compressive, tensile, or flexural strength.

In a preferred embodiment of the method, it is possible to ensure that the heat treatment is carried out at a temperature in the range of the glass transition temperature of the thermoplastic material.

As a result, this can provide a sufficient mobility of the polymer chains in the thermoplastic material of the starting granulate for volume reduction during heat treatment. Additionally, it is also possible to advantageously limit the duration of heat treatment needed for sufficient volume reduction.

In particular, it is possible to ensure that the heat treatment is carried out at a temperature selected from a range between 90° C. and 120° C.

This provides a suitable temperature range for non-melting heat treatment for most common foam material products made of expanded thermoplastic materials, and these foam material products can therefore be processed and/or recycled more efficiently using the method.

However, it is also possible to ensure that the heat treatment is carried out at ambient pressure.

This way, heat treatment can be performed without significant effort, even in easily erected heat treatment equipment such as furnaces or flow heaters.

In an advanced embodiment of the method, it is possible to select the length of time for heat treatment from a range of 0.01 to 50 h.

By selecting a duration for the non-melting heat treatment phase from the specified range, it is possible to purposely influence the respective desired bulk density of the intermediate granulate. Here, the selection of a length of time from the range mentioned above has proven to be particularly suitable for heat treatment. In particular, the ideal length of time for heat treatment phase can be selected from a range of 0.1 to 40 h, or more preferably 0.5 to 30 h.

A further expansion of the method would make it possible for the intermediate granulate to be separated by density and divided into several fractions of density following heat treatment.

This possibility results from the presence of the intermediate granulate in granular, pourable form. In this way, the intermediate granulate can be subjected to classification by density. The respective density fractions of the intermediate granulate can then be selectively used and/or applied during further processing. This form of procedural measure cannot be undertaken with the prior art, which relies on subjecting a body to heat treatment.

This also means that it is possible in the present method, for example, to restrict the intermediate granulate to a single density fraction for the subsequent molding of the foam material body.

In this way, foam material bodies with an especially unified density across all areas of the foam material body can be produced through the molding stage and/or local density differences in the foam material body can be prevented to the maximum extent. This in turn has a positive effect on the properties of the foam material body, especially on its mechanical properties.

A procedure may also be advisable in which at least one additive is added to the intermediate granulate before the foam material body is formed.

The type and quantity of additives can thus be selected based on the intended application and/or use of the respective foam material body. For example, additives can be added to improve the fire resistance of the foam material body. Further examples for possible additives can be color pigments, antioxidants, or light stabilizers. As opposed to the prior art, in which a mass is subjected to heat treatment, the measure mentioned above is possible in the present method since it forms and/or produces a pourable intermediate granulate during heat treatment.

In a further variant of the method, it can be provided for that the intermediate granulate and at least one additional, constructive element are placed in the molding cavity of the molding tool prior to molding the foam material body, whereby this (minimum of one) constructive element becomes an integral part of the foam material body during the molding process.

In contrast to the prior art, this measure also becomes possible, since a pourable intermediate granulate is produced through heat treatment. This procedural measure makes it possible to subsequently influence the mechanical properties of the foam material body even further. For example, it can be provided that one or more scrims or fabrics of fibrous material(s) are placed together with the intermediate granulate in the molding cavity of the lead part of the molding tool. Such scrims or fabrics may be formed, for example, from textile or plastic fibers. The additional use of such constructive elements can, for example, further increase the flexural strength of the foam material bodies. In contrast to the prior art with its heat treatment of a body, the present method also allows for this measure through the formation of a pourable intermediate granulate during heat treatment.

In an expanded embodiment of the method, it is possible to ensure that the intermediate granulate in the molding cavity is heated to a temperature selected from a range between 120° C. and 150° C. for the molding of the foam material body. Preferably, the intermediate granulate for shaping the foam material body in the molding cavity can be heated to a temperature selected from a range between 130° C. and 140° C.

A temperature selected from the specified range is suitable for material connecting the volume-reduced particles of the intermediate granulate in the molding cavity. In particular, the volume-reduced particles can thus be softened at the surface layer, and material connection can be achieved through surface bonding, sintering, and/or welding of the individual particles, thus producing a foam material body.

In principle, several possibilities for heating the thermoplastic material in the molding cavity are conceivable, such as molding tools heated by heating elements or heating media.

Preferably, it can be planned for that steam is introduced into the molding cavity for heating the intermediate granulate during the molding of the foam material body.

This makes it possible to provide a particularly efficient method for heating all areas of the molding cavity and/or all particles of the intermediate granulate in the molding cavity as rapidly and simultaneously as possible. In this way, for example, it is possible to prevent potential inhomogeneities in the resulting foam material bodies which may result from external heating of the molding cavity.

Furthermore, it is also possible during the molding process to allow for exposure of the intermediate granulate in the molding cavity to a mechanical stress selected from a range between 0.01 N/mm² and 2 N/mm², or preferably from a range between 0.1 N/mm² and 1 N/mm².

In this way, it is possible to effectively promote the material connection of the volume-reduced particles of the intermediate granulate in the molding cavity, thereby allowing for the production of a foam material body. As a further result of this, the duration of the molding stage can thus also be shortened advantageously. A mechanical stress can be applied to the intermediate granulate, for example, by pressing two molding parts of a molding tool together. As a result, the molding cavity can be reduced. In this case, for example, a molding part can be used and/or applied as press stamp.

In an advanced embodiment of the process, the pressure in the molding cavity can be lowered to ambient pressure at the end of molding of the foam material body and before solidification of the plastic material by cooling.

This can be done, for example, by opening one or more outlet elements rheologically connected to the molding cavity. At the same time or immediately following, the molding parts of a molding tool can be separated from one another prior to the solidification of the plastic material by cooling. This means that an expansion of the particles forming the foam material body and thus a re-expansion of the foam material body before the solidification of the plastic material can be achieved by the presumably still-existing overpressure in the interior of the particles versus ambient pressure. In the event of a uniaxial exposure of the intermediate granulate to a mechanical stress, for example through the design and use of a molded part as a press stamp, the density inhomogeneities arising from uniaxial exposure to a mechanical stress can be prevented in the manner mentioned above. In general, foam material bodies of particularly good quality can be produced using such a procedure.

In particular, it can also be ensured that a vacuum is generated in the molding cavity before the plastic material solidifies through cooling.

In this way, a further pressure difference between the interior of the particles and the molding cavity can be further increased, whereby it is possible to support a re-expansion of the particles forming the foam material body and/or of the foam material body itself.

The object of the present invention is, however, also solved by providing a foam material body, in particular one which can be produced according to one of the procedures specified in this document.

The foam material body has an overall density between 80 kg/m³ and 600 kg/m³, with specimens cut from any areas of the body having a density with a deviation of less than 20% from the overall density of the foam material body.

In this way, a foam material body can be provided which exhibits virtually no local inhomogeneities in its density. Therefore, any stress damages—for example as a result of areas having lower density than the overall density—can be prevented in this kind of foam material body.

In particular, it can be planned for that the value for the compressive stress at 10% compression lies between 0.9 N/mm² and 10.5 N/mm².

This allows for the provision of a foam material body which can withstand higher pressure loads.

For the purpose of a better understanding of the invention, the latter will be elucidated in more detail using the figures below.

These show in a highly simplified schematic representation:

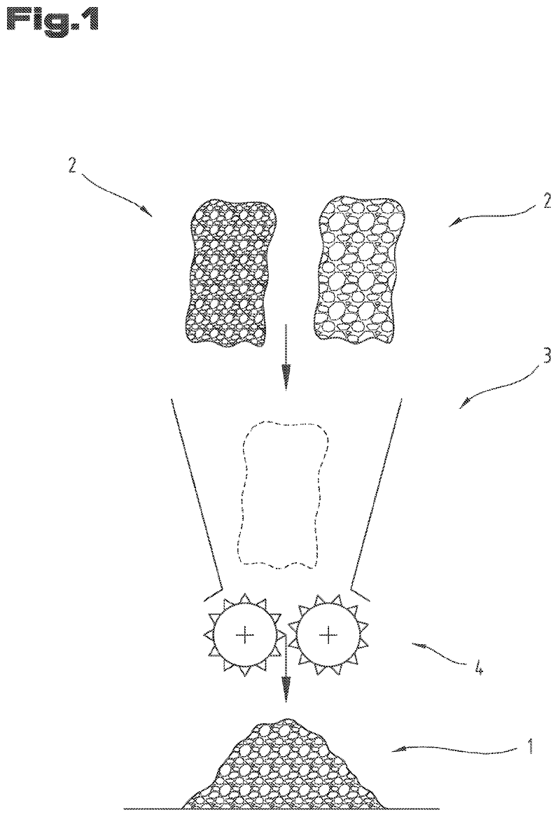

FIG. 1 An embodiment of a first process step in the present method for the production of a foam material body;

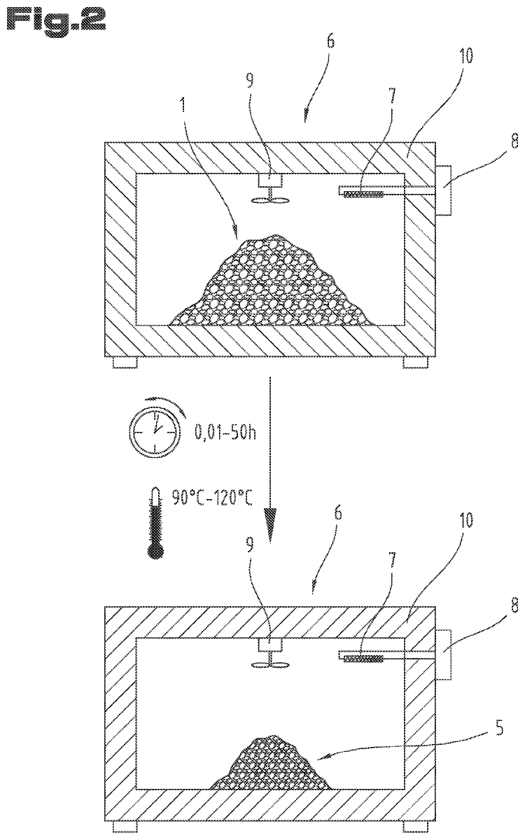

FIG. 2 An embodiment of a second process step in the present method for the production of a foam material body;

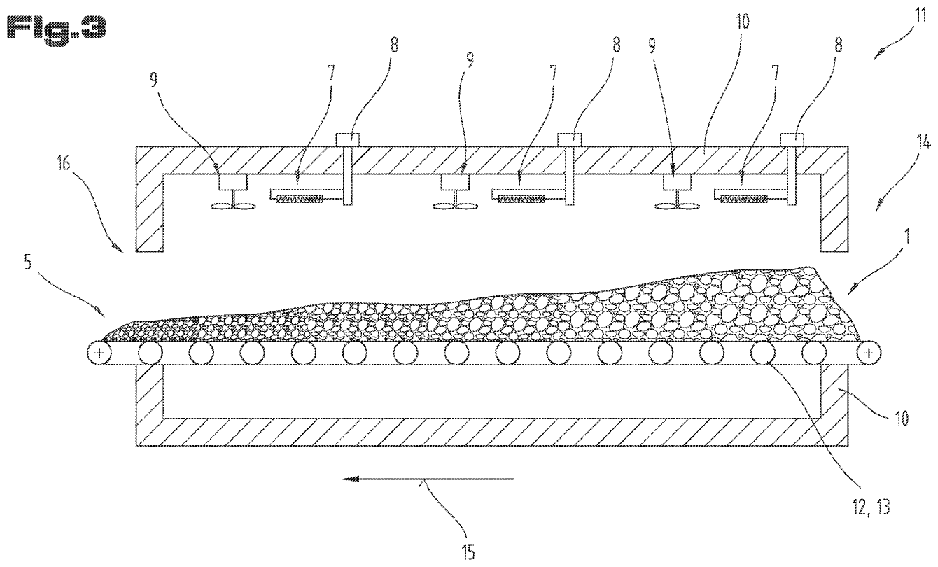

FIG. 3 A further example of an embodiment of the second process step in the present method for the production of a foam material body;

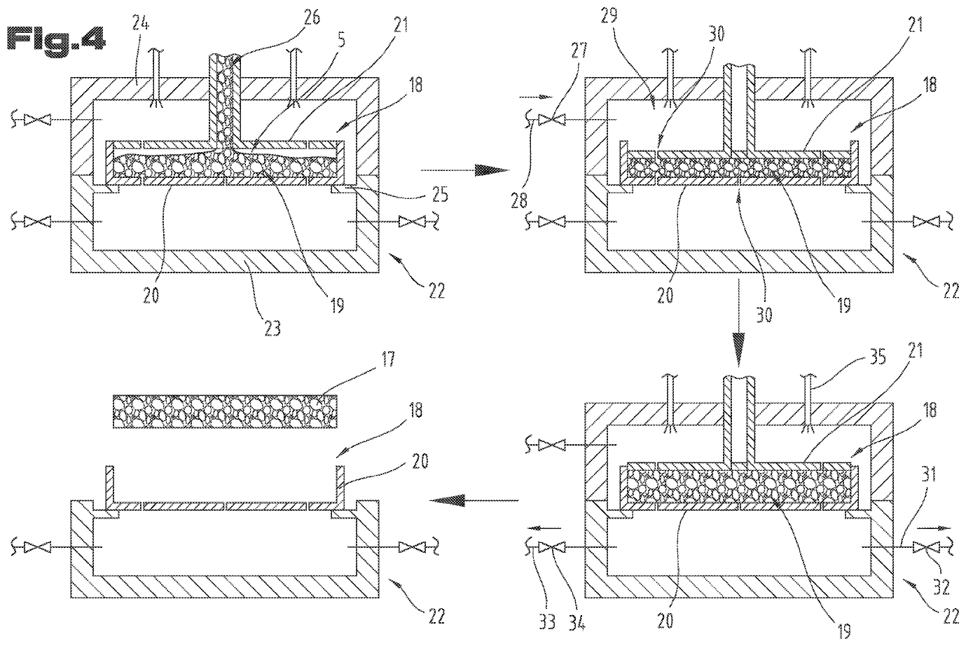

FIG. 4 An embodiment of a further step in the present method for the production of a foam material body;

As an introduction, it should be noted that in the different embodiments described, given parts are provided with given reference numbers and/or given component designations, wherein the disclosures contained in the overall description may be analogously transferred to given parts with the same reference numbers and/or the same component designations. Moreover, the specifications of location, such as “at the top,” “at the bottom,” or “at the side,” chosen in the description refer to the figure being directly described and depicted, and in case of a change of position, these specifications of location are to be transferred analogously to the new position.

The presented method for producing a foam material body comprises several process steps. The first process step concerns the preparation of a free-flowing and/or pourable starting granulate 1 composed of expanded particles of a thermoplastic material. In principle, any foamed material comprising expanded particles of a thermoplastic material, such as of polyolefins or polystyrene, can be used as the starting material and/or raw material. To this end, polystyrene-based foamed products are available in large quantities. For example, waste consisting of free-flowing, foamed polystyrene arising from the production of foamed polystyrene products may be provided as the starting material 1.

For example, additionally or as an alternative, it is also possible to ensure that foam material objects 2 made of thermoplastic material, such as packaging made from expanded polystyrene (EPS) or other recycled foam material objects 2 are crushed to form the starting granulate. In this case, comminution can be carried out by means of well-known comminution devices 3 such as via shredder 4 as shown purely schematically in FIG. 1.

It is quite possible that the foamed starting materials have different geometric shapes, dimensions, and densities and/or bulk densities. For example, foam material objects with different densities can easily be crushed to provide the starting granulate 1. Therefore, the resulting starting granulate can very feasibly, in such cases, already contain expanded particles and/or pieces of different bulk densities. For example, the starting granulate 1 can have a bulk density between 5 kg/m³ and 30 kg/m³.

Furthermore, it is possible that the starting granulate 1 contains slight residual soiling or impurities which have no significant influence on the subsequent stages or the foam material bodies produced by the process. Minor amounts of other substances, such as residual foaming agent or other substances used during the production of the starting material may also be present in the starting granulate, and these substances will also have no significant effect on the process or on the properties of the foam material bodies thereby produced.

Preferably, foamed material of at least predominantly one single thermoplastic material, for example polystyrene, will be provided as the starting granulate 1. This is partly because different thermoplastic materials may also have diverse (processing) characteristics such as diverging glass transition temperatures or mechanical properties. This may require different process parameters for different thermoplastic materials. Therefore, different plastic materials cannot efficiently be processed together.

After provision, the starting granulate 1 is further processed in a second step. As schematically illustrated in FIG. 2, in the second method step, a pourable and/or free-flowing intermediate granulate 5 having a bulk density higher than that of the starting granulate 1 is formed from the starting granulate 1. This is achieved by reducing the volume of the expanded particles of the starting granulate 1 by subjecting the starting granulate 1 to a non-melting heat treatment.

The starting granulate 1 can be placed in a furnace 6 for heat treatment; a suitable furnace 6 is illustrated in the flowchart shown as a sectional view in FIG. 2. As can be seen from the embodiment example shown in FIG. 2, the furnace 6 may, for example, comprise one or more heating elements 7 and a temperature control device 8. As a further example, a circulating air device 9 may also be provided. Preferably, the furnace 6 will also possess thermal insulation 10. The heating elements 7 can, for example, be provided by electrical heating elements, but also by infrared radiators or other heating devices. For heating the furnace 6, as an alternative to the heating elements 7 it is also possible to charge the furnace with a heated heat-transfer medium such as air, water vapor, or an air/water vapor mixture.

In order to initiate the volume reduction for the expanded particles of the starting granulate 1 as uniformly as possible, preferably the temperature in the furnace 6 will be increased slowly to the temperature desired for the respective heat treatment. In this case, the furnace 6 can be preheated in advance to a specific temperature, for example between 60° C. and 80° C., before the starting granulate 1 is placed in the furnace 6. During heat treatment, the desired temperature can be kept as constant as possible by means of the temperature control device 8.

Here it is possible to ensure that the heat treatment is carried out at a temperature within the range of the glass transition temperature of the thermoplastic material in the starting granulate 1. For example, it can be planned for that the heat treatment is carried out at a temperature selected from a range between 90° C. and 120° C. This temperature range is particularly useful for the heat treatment of the starting granulate 1 since, on the one hand, the volume of the particles of the starting granulate 1 prepared in the prior step can be sufficiently reduced at this temperature range. On the other hand, it is also possible to select a temperature for the heat treatment from the specified temperature range which is below any possible melting point of the thermoplastic material in the respective starting granulate 1, so that the particles do not bond during heat treatment. Furthermore, it has proven to be advantageous if the heat treatment is carried out at ambient pressure.

As is schematically illustrated in FIG. 2, the heat treatment causes a volume reduction for the particles of the starting granulate 1, so that an intermediate granulate 5 with reduced-volume particles is obtained after heat treatment. Accordingly, the intermediate granulate 5 has a greater bulk density than the starting granulate 1, as can also be seen in FIG. 2.

In principle, the extent of the volume reduction of the particles, and thus the desired bulk density for the intermediate granulate 5, can be influenced by the choice of temperature and duration for the heat treatment. On the one hand, selecting a higher temperature for the heat treatment will achieve an acceleration of the volume reduction of the particles. Higher temperatures can also increase the degree of volume reduction in the particles. On the other hand, by selecting a lower temperature for the heat treatment, the volume reduction will be slowed down, and in total the volume will be reduced to a lesser degree.

Moreover, by increasing the duration of the heat treatment, the degree of volume reduction for the particles can be increased, whereas a reduction in the duration of the heat treatment will cause a lesser degree of volume reduction. Preferably, a length of time for the heat treatment may be selected from a range between 0.01 h and 50 h, or even better from a range between 0.1 h and 40 h, and ideally from a range between 0.5 h and 30 h.

The volume reduction of the particles during heat treatment results from a reduction of internal stresses in the particles which arise from the previous foaming and freezing of the foamed structure during the production of the starting material. Through the reduction of these internal stresses, the kernel size of the particles decreases successively during heat treatment.

By selecting a respective temperature and duration for the heat treatment, it is possible to influence the bulk density of the intermediate granulate 5 obtained through heat treatment due to the reduction of the particles' value. A heat treatment temperature and duration sufficient to achieve a desired bulk density of the intermediate granulate 5 depends mainly on the nature of the thermoplastic material in the starting granulate 1 as well as on the bulk density of the starting granulate 1. Suitable temperatures and durations for the heat treatment can be determined for each case, for example by carrying out simple experiments.

For the production of foam material bodies with particularly useful insulating and mechanical properties, it has proven useful if through the heat treatment the bulk density of the intermediate granulate—as compared to the bulk density of the starting granulate prior to heat treatment—is increased to 5 times to 40 times the amount. For example, it is possible to ensure, via the heat treatment, that the bulk density of the intermediate granulate is set to a value selected from a range between 50 kg/m³ and 500 kg/m³.

FIG. 3 illustrates an embodiment variant of the non-melting heat treatment. In FIG. 3, the same reference numbers and/or component designations are used for the same parts as in the preceding FIGS. 1 and 2. In order to avoid unnecessary repetitions in the following, reference will be made to the detailed description in the preceding FIGS. 1 and 2.

In the embodiment of the method shown in FIG. 3, heat treatment is carried out continuously in a continuous furnace 11. The continuous furnace 11 shown in the sectional view has in turn several heating elements 7 controllable through one or more temperature control devices 8 as well as several circulating air devices, 9 and thermal insulation 10. In addition, a conveyor 12, for example a powered conveyor belt 13, is provided for transporting the particles through the continuous furnace 11.

The expanded particles of the starting granulate 1 can be fed continuously onto the conveyor 12 on the input side 14 of the continuous furnace 11 and conveyed through the continuous furnace 11 in a single feeding direction 15. In this case, the duration of the heat treatment can be determined through the selection of the conveying speed through the continuous furnace 11. Furthermore, it is possible to ensure, for example, that the temperature in the continuous furnace near the input side 14 is set lower than the temperature further inside the continuous furnace 11.

As illustrated in FIG. 3, the particles of the starting granulate 1 are again reduced in volume in the course of the heat treatment in the continuous furnace 11. After being transported through the continuous furnace 11, the intermediate granulate 5 having a bulk density higher than the bulk density of the starting granulate 1 can be obtained continuously at the output side 16 of the continuous furnace 11.

In one variant of the method, it is possible to ensure that the intermediate granulate 5 can be sorted into multiple density fractions after heat treatment. Separation by density can be carried out using conventional methods, such as wind sifting, centrifugation, settling and/or sedimentation, or heavy media treatment.

After division and/or classification of the intermediate granulate 5 into density fractions, it can be ensured as a further consequence that only intermediate granulate 5 of a single density fraction is used for the next process step. This process makes it possible to produce foam material bodies with a predominately uniform density across all areas, which ultimately has a positive effect on the characteristics—in particular the mechanical properties—of the foam material bodies.

A procedural process may also be desirable, during which at least one additive is added to the intermediate granulate prior to the molding of the foam material body. For example, an additive can be incorporated which improves the fire resistance of the foam material body. Further examples for possible additives can be color pigments, antioxidants, or light stabilizers.

Irrespective of the precise embodiment of the heat treatment stage and of any additional process steps that may follow, a further step for forming the foam material body 17 is carried out at this point. FIG. 4 gives a schematic depiction of one possible embodiment of the molding of the foam material body 17 by means of a molding tool 18. In FIG. 4, the same reference numbers and/or component designations are used for the same parts as in the preceding FIGS. 1 to 3. In order to avoid unnecessary repetitions, reference is made to the detailed description in the preceding FIGS. 1 to 3. FIG. 4 illustrates four states which occur during the step of forming the foam material body 17, whereby the arrows drawn between the states indicate a sequential sequence for the progression of the states. Also in FIG. 4, the elements and/or apparatuses depicted are additionally illustrated in sectional view.

As illustrated schematically in FIG. 4, the intermediate granulate 5 is filled into the molding cavity 19 of a molding tool 18 to form the foam material body 17. In the illustrated embodiment of the method, the molding tool 18 consists of a first molding part 20 and a second molding part 21, whereby the second molding part 21 is adjustable relative to the first molding part 20. In the example shown, the molding tool 18 is thus designed in the form of a molding press.

In the example shown in FIG. 4, the molding tool 18 and/or its molding parts 20, 21 are arranged in a lockable steam chamber 22 consisting of a first chamber section 23 and a second chamber section 24. As an alternative to the illustrated example, a steam chamber 22 may, as an example, also be made in one piece and have a lockable opening using a door or hatch to allow access to the molding tool 18, for example to remove a finished foam material body 17.

The first molding part 20 may be placed inside the steam chamber 22, for example on one or more support plates. The second molding part 21 may be connected to a uniaxial drive (not illustrated in detail) for adjusting the first molding part 21 relative to the second molding part 22.

The intermediate granulate 5 can be filled, for example, via injection line 26 into the molding cavity 19. Accordingly, as needed for the removal of excess intermediate granulate, the injection line 26 can be closed tightly against the molding cavity 19 by closing a hatch, e.g., again via compressed air or vacuum, as can be seen in the state illustrated at the top right of FIG. 4. Alternatively, for example, the first form part 20 can conceivably be filled manually while the form parts 20, 21 of the molding tool 18 are spaced apart.

In a variant of the method, it is also possible to ensure that the intermediate granulate 5 and at least one additional, constructive element are placed in the molding cavity 19 of the molding tool 18 before the foam material body is shaped. For reasons of clarity, this kind of constructive element is not shown in FIG. 4. For example, a constructive element may be formed using a fabric made of fibrous material. One or more such constructive elements can, for example, be inserted alternately with intermediate granulate 5 into the first molding part 20, whereby such an insertion can very feasibly be controlled by machine but may also be carried out manually. During the molding of the foam material body 17, this minimum of one constructive element becomes an integral component of the foam material body 17.

To form the foam material body 17, the intermediate granulate 5 is heated in the molding cavity 19 to a temperature greater than the glass transition temperature of the respective thermoplastic material. In the embodiment of the method shown in FIG. 4, the steam chamber 22 is fitted for this purpose a with steam connection 28, which is connected through a shut-off device 27 to a source of steam which is not shown in detail here. The source of the heated steam could be, for example, a heatable steam boiler.

For heating the intermediate granulate 5 during forming, steam can be introduced into a steam compartment 29 of the steam chamber 22 by opening the shut-off device 27. The form parts 20, 21 may be perforated as illustrated in FIG. 4 and have openings 30 through which the steam is introduced into the steam space 29 and also into the molding cavity 19. This allows for a very rapid and uniform heating of the intermediate granulate 5. Alternatively of course, other methods for heating the intermediate granulate 5 in the molding cavity 19 are conceivable, such as by infrared radiation or electrical heating elements.

In general, it can be ensured that for the formation of the foam material body 17, the intermediate granulate 5 in the molding cavity 22 is heated to a temperature selected from a range between 120° C. and 150° C. Preferably, the intermediate granulate for forming the foam material body in the molding cavity can be heated to a temperature selected from a range between 130° C. and 140° C.

By heating the intermediate granulate 5 in the molding cavity 19, the volume-reduced particles of the intermediate granulate 5 soften on the surface and the volume-reduced particles of the intermediate granulate 5 are materially connected through surface bonding, sintering, and/or welding so that a foam material body 17 is formed.

To support the material connection of the particles of the intermediate granulate 5, it can also be ensured that the intermediate granulate 5 is exposed, during molding in the molding cavity 19, to a mechanical stress selected from a range between 0.01 N/mm² and 2 N/mm², or ideally selected from a range between 0.1 N/mm² and 1 N/mm². This can be carried out, for example, by reducing the size of the molding cavity 19 by a powered adjustment of the second molding part 21 relative to the first molding part 20, as can be seen from the state illustrated at the top right of FIG. 4. In the illustrated example, a mechanical stress is applied, and/or the second molding part 21 is adjusted along an adjustment axis, i.e., uniaxially.

The heating of the intermediate granulate 5 in the molding cavity 19, potentially by applying a mechanical stress, can be carried out within, e.g., 3-20 seconds. The thermoplastic material used to create the foam material body 17 is then solidified through cooling.

In this context, preferably at the end of the forming of the foam material body 17 and prior to the solidification of the plastic material through cooling, pressure in the molding cavity 19 is reduced to ambient pressure. On the one hand, the second molding part 21 can be separated from the first molding part 20 for this purpose, as the state illustrated at the bottom left of FIG. 4 demonstrates. Furthermore, it is possible to ensure that any overpressure in the molding cavity 19 and/or the steam chamber 22 is reduced. In the example shown in FIG. 4, the first chamber section 23 is fitted with a drain line 31 with a shut-off device 32 for this purpose. By opening the shut-off device 32 of the drain line 31, the steam and other gases from the steam chamber 22, and therefore also from the molding cavity 19 can be drained, and this way the pressure in the steam chamber 22 and/or the molding cavity 19 can be lowered to ambient pressure.

As has been found in this case, such an approach can achieve an expansion of the particles forming the foam material body 17, and therefore a re-expansion of the foam material body 17 is achieved prior to the solidification of the plastic material. This most likely occurs due to overpressure still remaining in the interior of the particles in comparison to the ambient pressure.

In a further embodiment of the method, this kind of re-expansion process can also be further supported by generating vacuum in the molding cavity prior to the solidification of the plastic material by cooling. In the example shown in FIG. 4, the steam chamber 22 is fitted with a vacuum connection 33 for this purpose, which in turn can be effectively connected, for example to a vacuum pump, via shut-off device 34. When the shut-off device 34 is open and the vacuum pump is running, it is then possible to generate vacuum in the steam chamber 22 and/or the molding cavity 19.

As the final step of the molding stage, the foam material body 17 is solidified through cooling. Here the cooling of the product can be carried out passively—i.e., by the natural exchange of heat with its surroundings. Cooling can also be actively supported, in particular to shorten the time needed for solidification. For example, spraying devices 35 can be provided in the steam chamber 22, by means of which, e.g., cooling water can be sprayed onto the molding parts 20, 21 and/or into the molding cavity 19.

Finally, after the thermoplastic material has cooled down, the finished foam material body 17 can be removed after the two molding parts 20, 21 have been separated and the steam chamber 22 has been opened.

The foam material body 17 can fundamentally have a wide variety of geometric shapes and dimensions. This is primarily dependent on the geometric design of the molding cavity 19 of the molding tool 18. For example, it is possible to produce rectangular shaped foam material bodies 17 that are particularly well suited for construction purposes. The dimensions of such cuboid foam material bodies 17 can essentially be chosen arbitrarily, though cuboids having a length between 50 mm and 4,000 mm, a width between 50 mm and 15,000 mm, and a thickness between 10 mm and 200 mm have consistently proven effective. As already described, other geometric forms are also possible, for example foam material bodies 17 with a trapezoidal cross-section.

By means of the presented method, foam material bodies 17 can be produced with improved mechanical properties compared to, for example, the starting materials which are used to produce the starting granulate 1.

The foam material body 17 has an overall density between 80 kg/m³ and 600 kg/m³, and is characterized by the fact that specimens cut out from any areas of the foam material body 17 have a density with a deviation of less than 20% of the total density of the overall foam material body 17. By way of example only, such specimens may have dimensions of 10 cm×10 cm×10 cm. Thanks to a density so uniform across all areas, stress damage in particular can be avoided because the method inherently prevents problems caused, for example, by predetermined breaking points in areas of lower density. This also has a positive effect on the mechanical properties of the foam material body.

A compressive stress value at 10% compression of the foam material body will preferably lie between 0.9 N/mm² and 10.5 N/mm². For comparison, a compressive stress value at 10% compression in conventional foamed foam material objects, such as expanded polystyrene (EPS) packages or insulation boards, is about 0.2 N/mm² to 0.3 N/mm².

Therefore, in particular through the reduction in the volume of the particles and/or the respective increase in bulk density during heat treatment, the presented method allows for foam material bodies having significantly improved mechanical properties which nonetheless also boast, for example, good thermal insulation properties. Due to these improved mechanical properties, the foam material bodies 17 can also be used in areas which are not suitable for conventional foam material objects. For example, the foam material bodies can be used as load-bearing thermal insulation elements on the bases of buildings to avoid thermal bridges, or even for thermal decoupling of load-bearing components, such as between supports and ceilings.

The exemplary embodiments show possible embodiment variants, wherein it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of a person skilled in the art in this technical field.

The scope of protection is determined by the claims. However, the description and the drawings are to be adduced for construing the claims. Individual features or feature combinations from the different exemplary embodiments shown and described may represent independent inventive solutions. The object underlying the independent inventive solutions may be gathered from the description.

All statements of value ranges in this present description are to be understood to include any and all sub-ranges, e.g., if the descriptions states 1 to 10, it is to be understood that all subareas, starting from the lower limit 1 and the upper limit 10 are included, i.e., all subareas begin with a lower limit of 1 or greater and end at an upper limit of 10 or less, e.g. 1 to 1.7, or 3.2 to 8.1, or 5.5 to 10.

Finally, as a matter of form, it should be noted that for ease of understanding of the structure, elements are partially not depicted to scale and/or are enlarged and/or are reduced in size.

### LIST OF REFERENCE NUMBERS

| | |
|---|---|
| 1 | starting granulate |
| 2 | foam material object |
| 3 | comminution device |
| 4 | shredder |
| 5 | intermediate granulate |
| 6 | furnace |
| 7 | heating element |
| 8 | temperature control device |
| 9 | air circulation device |
| 10 | thermal insulation |
| 11 | continuous furnace |
| 12 | conveying means |
| 13 | conveyor belt |
| 14 | input side |
| 15 | transport direction |
| 16 | output side |
| 17 | foam material body |
| 18 | molding tool |
| 19 | molding cavity |
| 20 | molding part |
| 21 | molding part |
| 22 | steam chamber |
| 23 | chamber section |
| 24 | chamber section |
| 25 | support plate |
| 26 | injection line |
| 27 | shut-off device |
| 28 | steam connection |
| 29 | steam chamber |
| 30 | opening |
| 31 | drain line |
| 32 | shut-off device |
| 33 | vacuum connection |
| 34 | shut-off device |
| 35 | spraying device |

1: A method of producing a foam material body (17) comprising the following steps:
provision of a pourable starting granulate (1) of expanded particles of a thermoplastic material,
formation of a pourable intermediate granulate (5) having a bulk density higher than that of the starting granulate (1) through volume reduction of the particles of the starting granulate (1) by subjecting the starting granulate (1) to a non-melting heat treatment, and
molding of the foam material body (17) through material connection of the volume-reduced particles of the intermediate granulate (5) by heating the intermediate granulate (5) in a molding cavity of a molding tool (18) to a temperature greater than the glass transition temperature of the thermoplastic material, and by subsequently solidifying the thermoplastic material via cooling.

2: The method according to claim 1, wherein foam material objects are crushed from the thermoplastic material to provide the starting granulate (1).

3: The method according to claim 2, wherein foam material objects with different densities are crushed.

4: The method according to claim 1, wherein by heat treatment, a bulk density of the intermediate granulate (5) is increased to five times the amount to 40 times the amount with respect to the bulk density of the starting granulate (1) prior to heat treatment.

5: The method according to claim 1, wherein through the heat treatment a bulk density of the intermediate granulate (5) is set to a value selected from a range of 50 kg/m³ to 500 kg/m³.

6: The method according to claim 1, wherein the heat treatment is carried out at a temperature in the range of the glass transition temperature of the thermoplastic material.

7: The method according to claim 6, wherein the heat treatment is carried out at a temperature between 90° C. and 120° C.

8: The method according to claim 1, wherein the heat treatment is carried out at ambient pressure.

9: The method according to claim 1, wherein a duration for the heat treatment is selected between 0.01 h and 50 h.

10: The method according to claim 1, wherein the intermediate granulate (5) is separated by density into multiple density fractions after the heat treatment.

11: The method according to claim 10, wherein for subsequent molding of the foam material body, intermediate granulate of only one of the density fractions is used in each case.

12: The method according to claim 1, wherein at least one additive is added to the intermediate granulate prior to the molding of the foam material body.

13: The method according to claim 1, wherein prior to molding of the foam material body, the intermediate granulate and at least one additional, constructive element are placed in the molding cavity of the molding tool, wherein the at least one constructive element becomes a part of the foam material body in the course of molding the foam material body.

14: The method according to claim 1, wherein for molding of the foam material body (17) the intermediate granulate (5) is heated to a temperature selected from a range between 120° C. and 150° C. in the molding cavity (22).

15: The method according to claim 1, wherein for heating the intermediate granulate (5), steam is introduced into in the molding cavity (22) during molding.

16: The method according to claim 1, wherein a mechanical stress selected from a range between 0.01 N/mm² and 2 N/mm² is applied to the intermediate granulate (5) during molding in the molding cavity (19).

17: The method according to claim 1, wherein at the end of the molding of the foam material body (17), prior to the solidification of the plastic material by cooling, a pressure in the molding cavity (19) is lowered to ambient pressure.

18: The method according to claim 17, wherein a vacuum is generated in the molding cavity (19) prior to the solidification of the plastic material by cooling.

19: A foam material body (17) produced by means of the method according to claim 1, wherein it has an overall density between 80 kg/m³ and 600 kg/m³, and wherein samples cut out from any areas of the foam material body (17) have a density with a deviation of less than 20% from the overall density of the foam material body (17).

20: The foam material body according to claim 19, wherein the value for the compressive stress at 10% compression amounts to between 0.9 N/mm² and 10.5 N/mm².
